(19) United States
(12) Patent Application Publication
(10) Pub. No.: US 2020/0193873 A1
(43) Pub. Date: Jun. 18, 2020

(54) Satellite operation simulation device

(71) Applicant: Yaxin Shang, Guangzhou City (CN)

(72) Inventor: Yaxin Shang, Guangzhou City (CN)

(21) Appl. No.: 16/801,133

(22) Filed: Feb. 25, 2020

(30) Foreign Application Priority Data
Nov. 8, 2019 (CN) 2019110897020

(51) Int. Cl. G09B 27/02; G09B 9/00

(52) U.S. Cl. CPC G09B 27/02; G09B 9/00

(57) ABSTRACT

A satellite operation simulation device disclosed by the present invention includes a simulation box. The simulation box is provided with a simulation cavity, and an air suction pump is fixed in the inner wall on the right side of the simulation cavity. The air is drawn out and simulates the vacuum environment in space. The simulation cavity is provided with a simulation device. The simulation device generates a magnetic field through two magnetically opposite magnets, and the two magnets are connected through a magnetically conductive coil respectively. Hemispherical body, the device can perform human-computer interaction, thereby improving the personal experience of the person, and can artificially adjust the launch speed to simulate the operation of satellites at different launch speeds, and can emergency stop the device during operation to avoid accident occur.

### CROSS-REFERENCES TO RELATED APPLICATIONS

The present application claims priority from Chinese application No. 2019110897020 filed on Nov. 8, 2019 which is hereby incorporated by reference in its entirety.

### TECHNICAL FIELD

The present invention relates to the field of satellite, in particular to a satellite operation simulation device.

### BACKGROUND OF THE INVENTION

A satellite is a natural celestial body that orbits a planet and orbits in a closed orbit. Artificial satellites are also commonly referred to as satellites. You will learn about satellites in your school life, but only The satellite operation process can be viewed only through pictures and animations, and the satellite operation process shown by animations and pictures is ideal, without strong personal experience. A satellite operation simulation device described in the present invention can solve the above problems.

### BRIEF SUMMARY OF THE INVENTION

Technical problem: the current way of man-made satellites can only be learned through pictures and animations, without strong personal experience.

In order to solve the above problems, a satellite operation simulation device is designed in this example. A satellite operation simulation device in this example includes a simulation box, the simulation box is provided with a simulation cavity, and the right side of the simulation cavity is fixed in the inner wall. There is a suction pump, which can extract the air in the simulation cavity and simulate the vacuum environment in space. The simulation cavity is provided with a simulation device, and the simulation device is generated by two magnets with opposite magnetic properties. A magnetic field, and two of the magnets are connected to a hemisphere through a magnetically permeable coil, respectively, so that the two hemispheres have opposite magnetic properties, and balls are rotatably provided between the two hemispheres, and the balls simulate A satellite, and the ball is attracted by two pieces of the hemisphere, thereby simulating the gravity of the satellite during operation, a driving device is arranged in the right inner wall of the simulation cavity, and the driving device drives the impact hammer to impact The ball further enables the ball to start rotating in a tangential direction of the hemisphere, thereby simulating a satellite launch situation. The greater the impact force of the impact hammer, the ball The greater the launch speed, a buffer device is provided on the left inner wall of the simulation cavity, and the buffer device can buffer the impact hammer and prevent the impact hammer from rebounding. There is an emergency stop device, which can manually drive the emergency stop device and quickly stop the ball from rotating to avoid accidents. Links are fixedly connected between the left and right inner walls of the simulation cavity. Connect the buffer device and the driving device.

Advantageously, the driving device includes a transmission cavity provided in the right inner wall of the simulation cavity, and a sliding gear is rotatably and slidably provided in the transmission cavity, and a motor shaft is splined in the sliding gear. A motor is fixed in the inner wall of the lower side of the transmission cavity, and the lower end of the motor shaft is dynamically connected to the motor; an electromagnetic spring is fixedly connected between the upper end of the sliding gear and the motor shaft; A fixed gear is rotatably provided, and the fixed gear can be meshed with the sliding gear. A transmission shaft is fixedly connected to the fixed gear. A storage cavity is provided in the upper inner wall of the transmission cavity. A reel is rotatably provided, the reel is fixedly connected to the transmission shaft, a pull wire is wound on a peripheral surface of the reel, and a guide slider is slidably connected on the peripheral surface of the link. The impact hammer is fixedly connected to the front end of the guide slider, the left end of the pull wire is fixedly connected to the impact hammer, a compression spring is fixedly connected to the left inner wall of the simulation cavity, and the electromagnetic spring is energized to drive the electromagnetic spring. The sliding gear slides and meshes with the fixed gear At this time, the electric motor is started, and then the sliding gear is driven to rotate by the motor shaft, and the fixed gear is driven to rotate, and the reel is rotated by the transmission shaft, thereby pulling the pulling wire and driving The impact hammer slides to the right, while the impact slider drives the impact hammer to slide along the link and compresses the compression spring, de-energizes the electromagnetic spring, and further disengages the sliding gear from the The gear is fixed, and the impact hammer slides to the left and hits the ball under the elastic force of the compression spring.

Preferably, a reset torsion spring is fixedly connected between the upper end of the reel and the inner wall of the upper side of the storage cavity, and the elasticity of the reset torsion spring is small, and it is only used to drive the reel to rotate and tighten the The pull line.

Advantageously, the buffering device includes a fixing block fixedly connected to the left inner wall of the simulation cavity, the fixing block is provided with a buffer slot opening to the right, and the buffer slot is slidably provided with a buffer slider. The buffer slider is slidingly connected to the connecting rod. A check valve is provided in the inner wall of the upper and lower sides of the buffer groove symmetrically and the opening faces the simulation cavity. Initially, the buffer groove and the simulation cavity are provided. The internal air pressure is the same. After the impact hammer hits the ball, it continues to slide along the connecting rod, and then the impact hammer pushes the buffer slider to slide into the buffer groove, which can instantly increase the buffer groove. The internal air pressure and quickly slow the sliding of the impact hammer, and at the same time, the gas in the buffer tank can be discharged into the simulation cavity through the check valve, until the impact hammer stops sliding, at this time the buffer The groove and the simulation cavity remain the same, thereby preventing the impact hammer from rebounding.

Advantageously, the simulation device includes a cavity provided in the hemisphere and having opposite openings, the magnets on both sides are respectively fixed to the inner wall of the cavity away from the center of symmetry, and the magnetic conductive coil is connected to On the inner wall of the cavity, a connecting shaft is rotatably connected between the hemispheres. The front and rear ends of the connecting shaft are connected to the emergency stop device. A rotating rod is rotatably provided between the hemispheres. A rotating rod is fixedly connected to the connecting shaft. A sealing cavity with an upward opening is provided in the rotating rod. A telescopic rod is slidably provided in the sealing cavity. The upper end of the telescopic rod extends outside the sealing cavity. The telescopic rod is provided with a through hole penetrating back and forth, the ball can roll in the through hole, a protective pad is fixed on the surface of the telescopic rod, and the impact hammer strikes the protective pad to avoid damage. The ball pushes the telescopic rod and the rotating rod to rotate about the connection axis after the impact hammer strikes, and then the telescopic rod slides outward under the action of centrifugal force, while the ball is in the hemisphere. To the seal under the action of gravity The tendency to slip, and thus allow the ball around the oval track connecting shaft is rotated, and when the ball strikes the impact hammer, the ball nearest distance between the connection shaft.

Beneficially, the emergency stop device includes symmetrical gear chambers provided on the inner walls of the front and rear sides of the simulation chamber. Blocking gears are rotatably provided in the gear chambers. The front and rear ends of the connecting shaft respectively extend to The gear cavity is fixedly connected to the blocking gear. A groove is provided in the inner wall of the upper side of the gear cavity, and a barb lever is rotatably provided in the groove. The barb lever A torsion shaft is fixedly connected inside, and the torsion shaft is connected to the front and back inner walls of the groove in a rotational manner, and electromagnetic torsion springs are fixedly connected between the front and back ends of the barb rod and the inner walls of the front and back sides of the groove. Energizing the electromagnetic torsion spring can further drive the barb lever to rotate into the gear cavity, thereby blocking the blocking gear and forcibly stopping the connection shaft from rotating.

The beneficial effects of the present invention are: the device can perform human-computer interaction, thereby improving the personal experience of the person, and can artificially adjust the transmission speed, thereby simulating the operation of the satellite at different transmission speeds, and can stop urgently during the operation Device to avoid accidents.

### BRIEF DESCRIPTION OF THE DRAWINGS

For ease of explanation, the present invention is described in detail by the following specific embodiments and the accompanying drawings.

FIG. 1 is a schematic diagram of the overall structure of a satellite operation simulation device according to the present invention;

FIG. 2 is an enlarged schematic view of “A” of FIG. 1;

FIG. 3 is an enlarged schematic view of “B” of FIG. 1;

FIG. 4 is an enlarged schematic view of “C” of FIG. 1;

FIG. 5 is a schematic structural diagram of the “D-D” direction of FIG. 3;

FIG. 6 is a schematic structural diagram of the “E-E” direction of FIG. 3;

FIG. 7 is an enlarged schematic view of “F” of FIG. 6;

FIG. 8 is a schematic structural view of the “G-G” direction of FIG. 7.

### DETAILED DESCRIPTION OF THE INVENTION

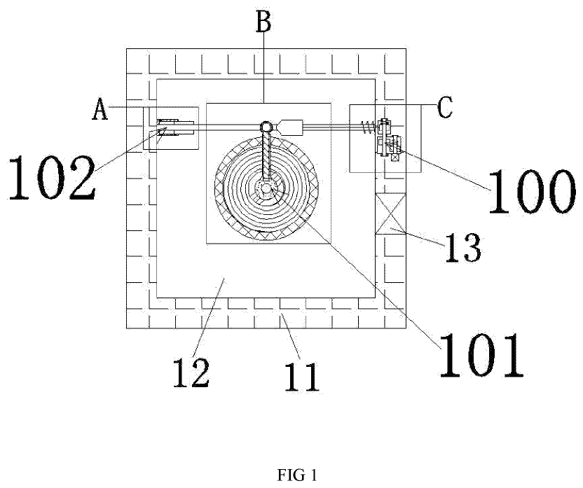

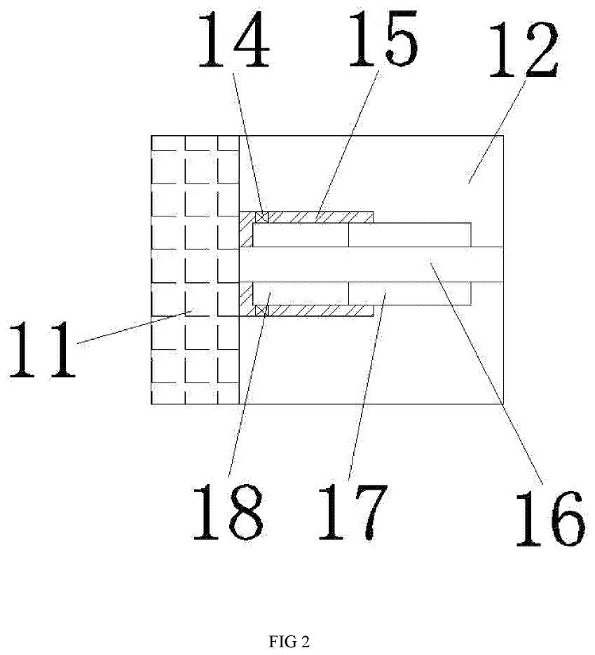

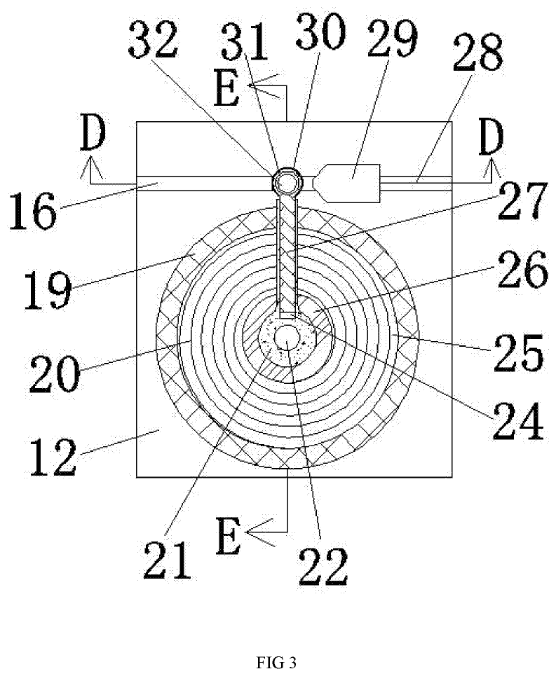

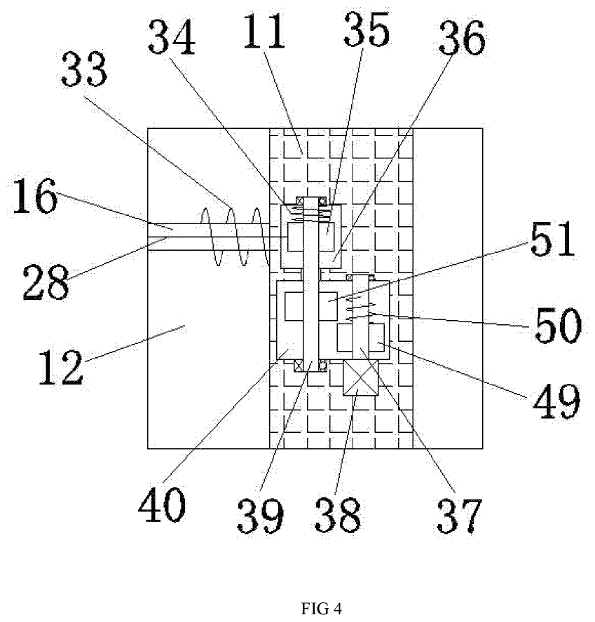

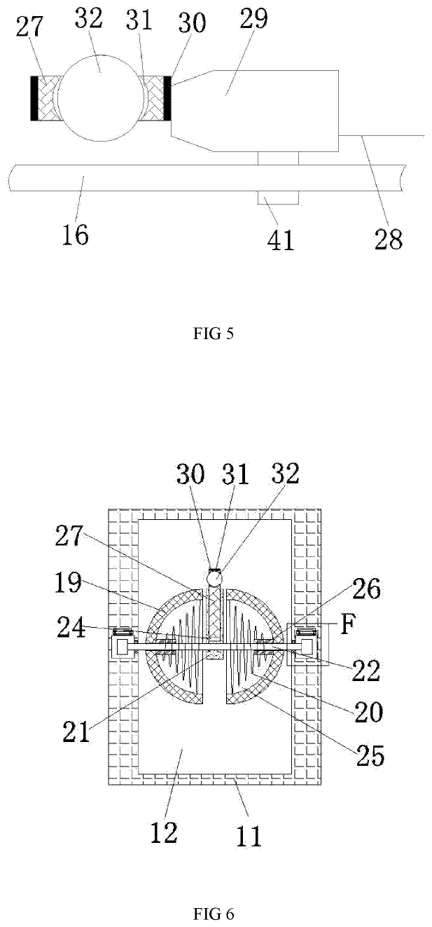

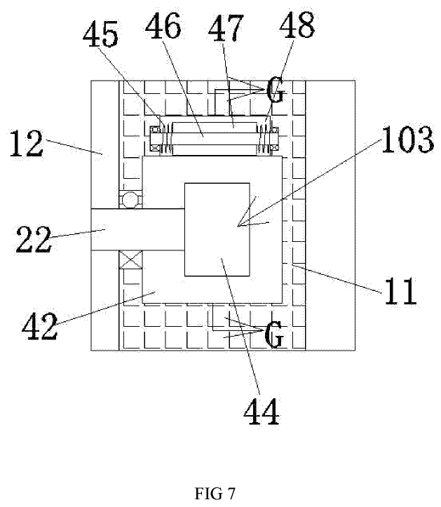

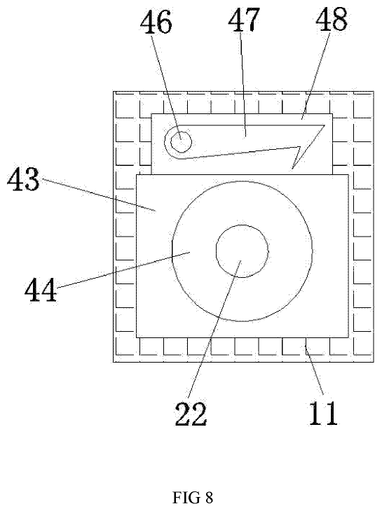

The present invention is described in detail below with reference to FIGS. 1 to 8. For convenience of description, the orientation described below is defined as follows: the up-down, left-right, front-back direction described below is consistent with the up-down, left-right, front-back direction of the projection relationship of FIG.

The present invention relates to a satellite operation simulation device, which is mainly applied to the satellite operation simulation process. The present invention will be further described below with reference to the accompanying drawings of the present invention:

A satellite operation simulation device according to the present invention includes a simulation box 11. The simulation box 11 is provided with a simulation cavity 12. A suction pump 13 is fixed in the right inner wall of the simulation cavity 12. The suction pump 13 The air in the simulation cavity 12 can be drawn out and a vacuum environment in space can be simulated. The simulation cavity 12 is provided with a simulation device 101. The simulation device 101 generates a magnetic field through two magnets 26 having opposite magnetic properties. The two magnets 26 are connected to a hemisphere 19 through a magnetically permeable coil 20, so that the two hemispheres 19 have opposite magnetic properties. A ball 32 is rotatably provided between the two hemispheres 19. The ball 32 simulates a satellite, and the ball 32 is attracted by two pieces of the hemisphere 19, thereby simulating the gravitational force received by the satellite during operation. A driving device 100 is provided in the right inner wall of the simulation cavity 12, and The driving device 100 drives the impact hammer 29 and impacts the balls 32, so that the balls 32 can start to rotate in a tangential direction of the hemisphere 19, thereby simulating a satellite launch situation, and the larger the impact force of the impact hammer 29 is, The ball 32 The greater the launch speed, a buffer device 102 is provided on the left inner wall of the simulation cavity 12, and the buffer device 102 can buffer the impact hammer 29 and prevent the impact hammer 29 from rebounding. The simulation cavity 12 There are emergency stop devices 103 in the inner walls of the front and back sides, which can artificially drive the emergency stop devices 103 and quickly stop the balls 32 from rotating to avoid accidents. There is a fixed connection between the left and right inner walls of the simulation cavity 12 The left and right ends of the rod 16 and the connecting rod 16 respectively connect the buffer device 102 and the driving device 100.

According to an embodiment, the driving device 100 is described in detail below. The driving device 100 includes a driving cavity 40 provided on the right inner wall of the simulation cavity 12. The driving cavity 40 is rotatable and slidable. A sliding gear 49 is provided. A motor shaft 37 is splined in the sliding gear 49. A motor 38 is fixed in the inner wall of the lower side of the transmission cavity 40. The lower end of the motor shaft 37 is power-connected to the motor 38. An electromagnetic spring 50 is fixedly connected between the upper end of the sliding gear 49 and the motor shaft 37. A fixed gear 51 is rotatably provided on the left side of the sliding gear 49, and the fixed gear 51 can be engaged with the sliding gear 49. A transmission shaft 39 is fixedly connected to the fixed gear 51. A storage cavity 36 is provided in the upper inner wall of the transmission cavity 40, and a reel 35 is rotatably provided in the storage cavity 36. The reel 35 is fixedly connected to the transmission shaft 39, a pull wire 28 is wound on the peripheral surface of the reel 35, a guide slider 41 is slidably connected on the peripheral surface of the connecting rod 16, and the impact hammer 29 is fixedly connected to the The front end of the guide slider 41, the left end of the pull wire 28 is fixedly connected to the impact hammer 29, and the simulation cavity 12 is left A compression spring 33 is fixedly connected to the inner wall, and the electromagnetic spring 50 is energized, thereby driving the sliding gear 49 to slide and mesh with the fixed gear 51. At this time, the motor 38 is started, and further driven by the motor shaft 37 The sliding gear 49 rotates, which in turn drives the fixed gear 51 to rotate, further drives the reel 35 to rotate through the transmission shaft 39, further pulls the pull wire 28 and drives the impact hammer 29 to slide to the right, and at the same time The guide slider 41 drives the impact hammer 29 to slide along the connecting rod 16 and compresses the compression spring 33, de-energizes the electromagnetic spring 50, and further disengages the sliding gear 49 from the fixed gear 51 At this time, the impact hammer 29 slides to the left and hits the ball 32 under the elastic force of the compression spring 33.

Beneficially, a reset torsion spring 34 is fixedly connected between the upper end of the reel 35 and the upper inner wall of the storage cavity 36. The reset torsion spring 34 has a small elastic force and is only used to drive the reel 35 to rotate. And tension the pull wire 28.

According to an embodiment, the buffer device 102 is described in detail below. The buffer device 102 includes a fixing block 15 fixed to the left inner wall of the simulation cavity 12. The fixing block 15 is provided with an opening to the right. The buffer groove 18 is slidably provided with a buffer slider 17, the buffer slider 17 is slidably connected to the link 16, and the buffer groove 18 is symmetrical in the inner wall of the upper and lower sides and the opening faces The simulation cavity 12 is provided with a one-way valve 14. Initially, the buffer groove 18 and the simulation cavity 12 have the same air pressure. The impact hammer 29 strikes the ball 32 and continues to slide along the connecting rod 16. Further, the impact hammer 29 pushes the buffer slider 17 to slide into the buffer groove 18, which can instantly increase the air pressure in the buffer groove 18 and quickly slow down the sliding of the impact hammer 29, while passing through The check valve 14 can discharge the gas in the buffer groove 18 into the simulation cavity 12 until the impact hammer 29 stops sliding, at this time the buffer groove 18 and the simulation cavity 12 remain the same. Further, the impact hammer 29 can be prevented from rebounding.

According to an embodiment, the simulation device 101 will be described in detail below. The simulation device 101 includes a cavity 25 provided in the hemisphere 19 and having opposite openings. The magnets 26 on both sides are respectively fixed to the cavity. The cavity 25 is located on the inner wall away from the center of symmetry. The magnetic coil 20 is connected to the inner wall of the cavity 25. A connecting shaft 22 is connected between the hemispheres 19 in rotation, and the connecting shaft 22 is connected at the front and rear ends. In the emergency stop device 103, a rotation rod 21 is rotatably provided between the hemispheres 19, the rotation rod 21 is fixedly connected to the connecting shaft 22, and an opening-up seal is provided in the rotation rod 21 A cavity 24 is provided with a telescopic rod 27 slidably provided in the sealed cavity 24. The upper end of the telescopic rod 27 extends out of the sealed cavity 24. The telescopic rod 27 is provided with a through hole 31 penetrating back and forth. The ball 32 can roll in the through hole 31, a protective pad 30 is fixed on the surface of the telescopic rod 27, and the impact hammer 29 hits the protective pad 30 to prevent damage to the ball 32. The impact hammer 29 pushes the telescopic rod 27 and the rotating rod 21 to rotate about the connecting shaft 22 after the impact. Further, the telescopic rod 27 slides outward under the action of centrifugal force, and at the same time, the ball 32 has a tendency to slide into the sealed cavity 24 under the gravity of the hemisphere 19, so that the ball 32 can be wound around the The connecting shaft 22 rotates in an elliptical trajectory, and when the ball 32 and the impact hammer 29 collide, the distance between the ball 32 and the connecting shaft 22 is the shortest.

According to an embodiment, the emergency stop device 103 will be described in detail below. The emergency stop device 103 includes a gear cavity 42 symmetrically disposed in the inner wall of the front and rear sides of the simulation cavity 12. The gear cavity 42 is rotatable. A blocking gear 44 is provided. The front and rear ends of the connecting shaft 22 respectively extend into the gear cavity 42 and are fixedly connected to the blocking gear 44. The upper inner wall of the gear cavity 42 is provided in communication with each other. A groove 48 is provided with a barb lever 47 rotatably provided in the groove 48. A torsion shaft 46 is fixedly connected to the barb lever 47. The torsion shaft 46 is rotatably connected to the groove 48 at the front and rear ends. In the front and back inner walls, electromagnetic torsion springs 45 are fixedly connected between the front and back ends of the barb lever 47 and the inner walls on the front and back sides of the groove 48, and the electromagnetic torsion spring 45 is energized, thereby driving the barb lever 47 Turning into the gear cavity 42 can further block the blocking gear 44 and forcibly stop the connecting shaft 22 from rotating.

The following describes in detail the use steps of a satellite operation simulation device in this article with reference to FIGS. 1 to 8:

Initially, the ball 32 is facing the impact hammer 29 and the impact hammer 29 is located on the right side of the ball 32. At this time, the electromagnetic spring 50 is in a power-off state. At this time, the sliding gear 49 and the fixed gear 51 are not meshed. At this time, the electromagnetic torsion spring 45 is not energized. At this time, the barb bar 47 is accommodated in the groove 48, and the magnets 26 on both sides make the hemispheres 19 on both sides magnetic through the magnetic coil 20, and the hemispheres 19 are attractive to the balls 32.

When in use, the suction pump 13 is started, and then the air in the simulation cavity 12 is extracted, and the space environment is simulated in the simulation cavity 12. At this time, the buffer tank 18 and the simulation cavity 12 have the same air pressure. At this time, the electromagnetic spring 50 is energized and started The motor 38 and the electromagnetic spring 50 drive the sliding gear 49 to slide and mesh with the fixed gear 51. At this time, the motor 38 drives the sliding gear 49 to rotate through the motor shaft 37, thereby driving the fixed gear 51 to rotate, and further drives the reel through the transmission shaft 39 35 rotates and twists the reset torsion spring 34, while the reel 35 winds the pull wire 28 and pulls the impact hammer 29 to slide to the right, and at the same time, the guide slider 41 drives the impact hammer 29 to slide along the connecting rod 16 and compress the compression spring 33. The activation time of 38 is to adjust the degree of compression between the impact hammer 29 and the compression spring 33. The greater the compression degree of the compression spring 33, the greater the impact force between the impact hammer 29 and the ball 32, so that the ball 32 can be adjusted. When the compression force between the impact hammer 29 and the compression spring 33 is adjusted, the electromagnetic spring 50 is powered off, and the sliding gear 49 is pushed to slide and disengage from the fixed gear 51. It is pushed under compression force of spring 33 slide hammer 29, in turn impinges on the protective pad 30, while the reel 35 rotates in the wire 28 and the tension of the return spring force of the torsion spring 34, the wire 28 to avoid scattered.

After the impact hammer 29 collides with the protective pad 30, it continues to slide along the connecting rod 16 to contact the buffer slider 17 and push the buffer slider 17 to slide into the buffer groove 18. At this time, the air pressure in the buffer groove 18 instantly increases and slows down. The sliding speed of the impact hammer 29, and the gas in the buffer tank 18 is exhausted into the simulation chamber 12 through the check valve 14, so that the air pressure in the buffer tank 18 and the pressure in the simulation chamber 12 are dynamically balanced until the impact hammer 29 stops.

After the impact hammer 29 hits the protective pad 30, it pushes the telescopic rod 27 and the rotating rod 21 to rotate. Under the action of centrifugal force, the telescopic rod 27 will slide out of the sealed cavity 24, and the greater the rotation speed of the telescopic rod 27, the more the sliding distance of the telescopic rod 27 will be. The larger the distance between the ball 32 and the connecting shaft 22 is, the more the ball 32 has the tendency to push the telescopic rod 27 to slide into the sealed cavity 24 under the attraction of the hemisphere 19, and the ball 32 will rotate around the connecting shaft 22 Rotate in an elliptical trajectory, and the ball 32 is closest to the connecting shaft 22 in the launch position.

When the rotation lever 21 rotates, the connecting shaft 22 is rotated, which in turn drives the blocking gear 44 to rotate. When an emergency stop device is required, the electromagnetic torsion spring 45 is energized, which further drives the barb lever 47 to rotate and catch the blocking gear 44, thereby forcibly. The connection shaft 22 is stopped, and the device can be restored to the initial state at this time.

The beneficial effects of the present invention are: the device can perform human-computer interaction, thereby improving the personal experience of the person, and can artificially adjust the transmission speed, thereby simulating the operation of the satellite at different transmission speeds, and can stop urgently during the operation Device to avoid accidents.

In the above manner, those skilled in the art can make various changes according to the working mode within the scope of the present invention.

1. A satellite operation simulation device includes a simulation box, which is characterized in that: a simulation cavity is provided in the simulation box, and an air suction pump is fixed in the inner wall on the right side of the simulation cavity; The air is drawn out and simulates the environment of vacuum space; the simulation cavity is provided with a simulation device, and the simulation device generates a magnetic field through two magnets with opposite magnetic properties, and the two magnets are connected to a hemisphere through a magnetically conductive coil A satellite is rotatably provided between the two hemispheres, and the ball simulates a satellite; a driving device is arranged in the right inner wall of the simulation cavity, and the driving device impacts the balls by driving an impact hammer. Then, the satellite launch situation is simulated; a buffer device is provided on the left inner wall of the simulation cavity, and the buffer device can buffer the impact hammer and prevent the impact hammer from rebounding; There is an emergency stop device inside, which can manually drive the emergency stop device and quickly stop the ball from rotating to avoid accidents; there is a connection between the inner walls of the left and right sides of the simulation cavity. The left and right ends are connected to said link means and said driving buffer device.

2. The satellite operation simulation device according to claim 1, wherein the driving device comprises a transmission cavity provided in an inner wall on the right side of the simulation cavity, and the transmission cavity is rotatable and slidable. There is a sliding gear, a motor shaft is splined inside the sliding gear, a motor is fixed in the lower inner wall of the transmission cavity, and the lower end of the motor shaft is dynamically connected to the motor; the upper end of the sliding gear is connected to the motor An electromagnetic spring is fixedly connected between the shafts; a fixed gear is rotatably provided on the left side of the sliding gear, the fixed gear can mesh with the sliding gear, and a transmission shaft is fixedly connected to the fixed gear; A storage cavity is arranged in the inner wall on the upper side of the cavity, and a reel is rotatably provided in the storage cavity, the reel is fixedly connected to the transmission shaft, and a pull wire is wound on the peripheral surface of the reel; A guide slider is slidably connected to the peripheral surface of the connecting rod, the impact hammer is fixed to the front end of the guide slider, the left end of the pull wire is fixed to the impact hammer, and the left inner wall of the simulation cavity is fixed to the impact hammer. With compression spring.

3. The satellite operation simulation device according to claim 2, wherein a reset torsion spring is fixedly connected between the upper end of the reel and the upper inner wall of the storage cavity.

4. The satellite operation simulation device according to claim 1, wherein the buffer device comprises a fixing block fixed on the left inner wall of the simulation cavity, and the fixing block is provided with a buffer opening to the right. The buffer groove is slidably provided with a buffer slider, and the buffer slider is slidably connected to the link; the upper and lower sides of the buffer groove are symmetrically arranged in the inner wall and the opening faces the simulation cavity. Check valve.

5. The satellite operation simulation device according to claim 1, wherein the simulation device comprises a cavity provided in the hemisphere with opposite openings, and the magnets on both sides are respectively fixed to the cavity. On the inner wall away from the center of symmetry, the magnetic coil is connected to the inner wall of the cavity; a connecting shaft is rotationally connected between the hemispheres, and the front and rear ends of the connecting shaft are connected to the emergency stop device; A rotation rod is rotatably provided between the hemispheres, the rotation rod is fixedly connected to the connecting shaft, a sealing cavity with an upward opening is provided in the rotation rod, and a telescopic rod is slidably provided in the sealing cavity. The upper end of the telescopic rod extends out of the sealed cavity. The telescopic rod is provided with a through hole penetrating back and forth, and the ball can roll in the through hole; the surface of the telescopic rod is fixed with protection pad.

6. The satellite operation simulation device according to claim 5, characterized in that the emergency stop device comprises gear chambers symmetrically arranged in the inner walls of the front and rear sides of the simulation chamber, and the gear chambers are rotatable. There is a blocking gear, the front and rear ends of the connecting shaft respectively extend into the gear cavity and are fixedly connected to the blocking gear; a groove is provided in the inner wall of the upper side of the gear cavity, and the groove is connected with each other. An internally rotatable barb bar is provided. The barb bar is fixedly connected with a torsion shaft. The front and back ends of the barb shaft are rotatably connected to the front and rear inner walls of the groove. Electromagnetic torsion springs are fixedly connected between the inner walls of the front and back sides of the groove.
